(19) United States
(12) Patent Application Publication
(10) Pub. No.: US 2018/0065802 A1
(43) Pub. Date: Mar. 8, 2018

(54) METHOD FOR CONVERTING SECONDARY BIOLOGICAL MATERIAL INTO REUSABLE ENERGY AND FOR STORING SAID MATERIAL, ENCASING METHOD, AND ENCASING DEVICE AND ENCASING MATERIAL HEREFOR

(71) Applicant: Rotho Babydesign GmbH, Wadern-Nunkirchen (DE)

(72) Inventor: Fritz SCHMITT, Trier (DE)

(21) Appl. No.: 15/560,417

(22) PCT Filed: Mar. 22, 2016
(86) PCT No.: PCT/DE2016/000124

§ 371 Date: Sep. 21, 2017

(30) Foreign Application Priority Data
Mar. 22, 2015 (DE) 20 2015 002 302.9
Jul. 11, 2015 (DE) PCT/DE2015/000346

(51) Int. Cl. B65F 1/00; B09B 5/00; B09B 3/00; B65F 1/06

(52) U.S. Cl. CPC B65F 1/0026; B09B 5/00; B09B 3/00; B65F 1/062; B32B 2307/7163; B65F 2250/105; B65F 2210/1026; B65F 2240/132; B65F 2240/136; B65F 2240/164; B32B 2307/724

(57) ABSTRACT

The invention relates to a method for converting secondary biological material into reusable energy and for storing said material, said method initially packages, transports, and stores the secondary biological material in portions in at least one gas-tight encasing material in at least one layer. The encasing material and/or a material added to the secondary biological material hereby promotes production of at least one gas in the casing. Further, the invention relates to an encasing method for sealing secondary biological material in portions in casings comprising at least one transport device which is designed to form an accommodation depression together with the first encasing material. The invention further relates to an encasing device for sealing secondary biological material in portions in a sealed casing for each portion comprising at least one fill opening for accommodating a portion of the secondary biological material to be sealed on an encasing material in at least one accommodation body. An encasing material according to the invention comprises a flat, single web or multiple flat webs in multiple layers or a tube, comprising at least one gas-impermeable layer.

The invention relates to a method for converting secondary biological material into reusable energy and for storing said material, encasing method, and encasing device and encasing material herefor. When describing the field associated with the invention, nutrient recycling, the recovery of usable materials, e.g., from urine, or secondary bioenergy may be cited. The invention rather relates to an encasing method and an encasing device, as, for example, specified in PCT/DE2015/000346. In particular with respect to the encasing material, the invention relates to a gas-tight stretchable film, as specified in DE 20 2015 002 302. The content of this international patent application and this utility model are completely incorporated as references.

The invention considers secondary biological material to be, for example, food waste, slaughterhouse waste, fats, fruit wastes, vegetable wastes, compost in all stages, sewage sludge, used diapers, used hygienic articles, protein-rich industrial wastes, carbohydrate-rich industrial wastes, grease trap residues.

The present energy supply is primarily supported by fossil fuel sources, oil, coal, and natural gas, as well as nuclear energy. The problems and risks resulting therefrom have long been known. The possibilities for using renewable energies are known to be manifold. Different technologies have long facilitated direct (e.g., photovoltaic) or indirect (e.g., hydroelectric and wind power, and also bioenergy) use of solar energy. High expectations are set for the use of biomass for energy. In Europe and Germany, biomass has been the most commonly used renewable energy source thus far. According to the desires of the European Union, biomass should—due to the large untapped potential and the relative proximity to market, in comparison to many other options for using renewable energies—provide in the future an even greater contribution to the energy system and thus noticeably contribute to the construction of a future environmentally-sound and climate-friendly, and thus sustainable, energy supply. Bioenergy designates energy obtained from biomass. Different forms of energy, like heat, electrical energy, or even fuel for internal combustion engines, are thereby included. In addition, biomass, in which the energy is chemically stored, is often designated as bioenergy. Renewable raw materials are used as the primary energy source.

The primary goal of this invention is to convert present biomass, thus the wastes from food and human and animal excrement, directly into usable energy. Agricultural land would then not have to be used to generate biomass exclusively for energy generation. One advantage of secondary biomass, which does not comprise extra cultivated energy contributors, is based on its constant availability, in particular, at the locations where a lot of energy is required. Fossil fuel energy reserves might be preserved through the use of secondary biomass.

The underlying problem of the invention is solved by a method for converting secondary biological material into reusable energy and for storing said material comprising all features of claim 1, an encasing method for sealing secondary biological material in portions according to claim 3, an encasing device according to claim 4, and an encasing material according to claim 5.

Advantageous embodiments are specified in the subclaims and in the subsequent description.

Secondary biomass may contribute to the reduction of greenhouse gas emissions. During the incineration of biomass, only as much carbon dioxide is released as was previously absorbed from the atmosphere during photosynthesis. In the case of bioenergies from excrements, food wastes, etc., it must be taken into consideration that, for example, nitrous oxide or methane is generated during generation and use, and except for the solids, may likewise be used and stored. This thought underlies the invention, which is concerned with, for example, how the secondary bioenergy may be handled up to its exploitation in order to be economical.

Together with biogenetic residues, bioenergy may provide 16 to 35 percent of the world energy demand according to publically researchable sources. Due to economic and political restrictions; however, an exploitation of the potential of only approximately half is possible (i.e., 8 to 17.5 percent of the world energy demand). The additional reuse of secondary biomass is not considered in all of these calculations and studies. Together with biogenetic residues, half of the total world energy demand may be covered with the aid of secondary biomass, without causing usage competition with conservation of food supplies.

In Germany alone, approximately 18.4 million metric tons of food ends up in the trash. If biofuels are intensively cultivated in agriculture, this leads to environmental pollution. In general, pesticides and mineral fertilizers are used, which may lead to surface water and ground water pollution, and whose manufacturing is additionally energy intensive.

Since bioenergy is, unlike wind and solar radiation, easily storable, it is viewed as an important balancing energy for future electrical supply (virtual power plant). Scientists propose using bioenergy for combined energy and heat generation (combined heat and power) instead of for fuel. A disadvantage of the method currently used is that a lot of energy is allocated to produce the biomass.

At the same time, researchers, aid workers, and engineers from around the world have been fiddling for decades on the question of toilets. Thus, there are, for example, dry toilets, in which the fecal matter is fed into straw-lined containers and composted; bag toilets, in which chemicals kill the bacteria; and toilets which convert urine into fertilizer.

However, up until now, none of these technologies has had a breakthrough. A solution is urgently needed: according to information from the World Health Organization, more than 2.5 billion people around the world live without access to toilets.

The goal of the invention is to create a type of energy generation that uses available secondary biomass to generate energy. For example, the secondary biomass is packaged and, if necessary stored, directly by the end consumer/user, such that autonomously storable energy, e.g., methane, is generated, in particular by the type of packaging.

In this context, the invention proposes to convert, in particular human and animal feces, into energy, primarily because human and animal feces are not only methane stores but also methane generators. Up until now, aqueous biomass waste from humans and animals, thus primarily from the sewer systems of our cities and wastes from agriculture, have not been efficiently used. According to one principle of the invention, positive or negative pressure may be adjusted between two films in order to filter gas from an inner pouch. The pore size of the inner film corresponds to the material to be permeated. Thus, a classifying effect may be achieved by a casing according to the invention.

One solution according to the invention comprises a packaging unit for secondary biomass. The invention proposes an advantageous encasing device which packages the secondary biomass in portions in the encasing material according to the invention. The packaging according to the invention of advantageous embodiments comprises multiple layers, for example, multiple films or layer films, wherein each film or film layer has specific properties, for example, converting secondary biomass into storable energy, e.g. methane gas or other forms of energy sources and simultaneously storing the secondary biomass.

A casing is, in the meaning of the invention, not only a film or a paper in which secondary organic material is wrapped until it is tightly sealed. An encasing material in the meaning of the invention may also be an endless material from a cartridge, a disposable glove, or a hygienic article, like diapers or sanitary napkins or parts thereof or thereon.

The encasing films, according to advantageous embodiments of the invention, may be, for example, coated in such a way that a gel on the film has at least one first organic component and at least one second inorganic component for optimizing the methane gas formation so that a flora of microorganisms on the coated surface achieves a significant increase in efficiency in the biogas process, thus increasingly converts secondary bioenergy into methane gas or other forms of energy sources. To generate energy from secondary biomass, according to advantageous embodiments of the invention, methane gas formers and heat are thereby preferably used, for example, solar energy which radiates on black casings stored temporarily under open sky.

Indeed, meat-packaging methods are known, for example, in which prior to or during the gas-tight closing, nitrogen, for example, is added to primarily organic material, so that aerobic bacterial activity is at least curbed. The underlying idea of the invention lies completely opposite that for the case of meat, that—at least starting at a certain time—such aerobic activity is desired in order to form methane. Therefore, advantageous encasing materials for meat have a first life cycle that preserves, and a second life cycle for providing targeted energy. After a certain preservation time, encasing materials developed for this purpose would activate methane gas formers in a targeted way, so that, due to the plump packaging, there may be no doubt that the preservation has expired. In this way, labeling swindling may be prevented. The nitrogen would be bonded, for example, after the expiration of the preservation limit, to the inner casing surface, preferably through passage of oxygen into the casing interior.

In one advantageous casing according to the invention, organic materials are decomposed by the action of bacteria. When using suitable bacteria, methane gas is hereby produced, which is usually supplied to a generator to generate electrical energy. One essential influencing factor in this case is the reproduction rate of the useful bacteria. One problem consists in that bacteria are contained in the biomass that compete with one another. An advantageous embodiment of the invention solves this problem in that suitable preparations, which promote the reproduction of the useful bacteria, are added to the biomass to be decomposed. Both the efficiency of basically known preparations and also the necessary preparation amounts per metric ton of biomaterial have been previously perceived as inadequate. The present invention therefore seeks to improve such a preparation in such a way that the reproduction of useful bacteria is sufficiently supported at a comparatively low amount of preparation. According to one embodiment according to the invention, the preparation is placed directly in or on the packaging unit for secondary biomass. According to one advantageous embodiment of the invention, a nutrient medium, which promotes the reproduction of the preparation and simultaneously inhibits the reproduction of additional bacteria that are not seen as useful bacteria, may be coated, for example, on an advantageous encasing film.

In another advantageous embodiment, this problem is solved in that the first component of a coating comprises material that provides the bacteria with an optimal environment for reproduction. One coating of the film or the film itself, as a nutrient medium, leads to an optimal environment for the useful bacteria. The coating material or the film itself hereby functions both as additional food for the bacteria and additional leads to optimal environmental conditions. In addition, the reproduction of the additional bacteria that are not seen as useful bacteria is inhibited.

Advantageous coatings of encasing materials according to the invention or the encasing materials themselves contain, for example, in increased concentration, combination, or purity:
potassium, sodium, ammonium, magnesium,
magnesium alginates, alkaline metals or alkaline earth metals,
vegetable amino acids, salts, alkalis, nutrient salts, trace nutritional elements,
oxides, hydroxides or carbonates, phosphates or trace nutritional elements (Zn, Cu, Mn, Co, Ni, Mo, Cl, Se, and others),
amino acids and other proteins, namely vegetable, animal, or synthetic proteins.

Within the meaning of the invention, all materials may be considered which function to produce methane gas. The film of one advantageous embodiment emits such promotional materials as a residual monomer.

In advantageous embodiments of the invention, the packaging unit for the secondary biomass is matched to a specific biomaterial.

An advantage of the invention is shown in that the addition of a nutrient medium in or on the packaging of the secondary biomass, in particular at a beginning of the biogas production, is a substantial advantage, since optimized reproductive conditions are thus provided for the useful bacteria over the additional bacteria. According to a corresponding priming composition, while the material does have an additional positive effect on the reproduction of bacteria, this is already reinforced in such a way, however, that clear reproductive advantages are present over the other bacteria. According to the corresponding priming composition, a substantial part of the promotional effect of the coating material consists in an optimization of the metabolism of the useful bacteria and thus increased production of biogas.

According to one advantageous embodiment, a first component of the coating is produced on the basis of biological material that serves the bacteria as a nutrient medium. The goal was, for example, to solubilize the entire coating material using alkali metals like potassium, sodium, ammonium, magnesium, etc. with the addition of water, such that a coating is produced which is appropriate as a carrier material for, e.g., potassium, sodium, ammonium, or magnesium alginates. Also for amino acids, vitamins, hormones, laminarin, Focucin, betain, and many other vegetable materials.

Inorganic materials were preferably used as the second component of such advantageous embodiments. Clay minerals, like montmorillonite, vermiculite, kaolinite, powdered minerals, in combination with pulped or unpulped algae, led to improvement in the biogas bacteria and methane gas bacteria. Advantageously small amounts of clay minerals are used for the improved activity of the bacteria in the combination.

Inorganic materials may likewise be used as the third component of such advantageous embodiments. Oxides, hydroxides, and salts, like potassium, sodium, calcium, magnesium, iron, and ammonium salts function in the combination for improved sulfur bonding. In generating electricity, the sulfur bonding protects the motors of the electrical generators from sulfuric acid corrosion and corrects or buffers the pH value in the packaging unit.

Inorganic materials are also used as a fourth component in a particularly preferred embodiment. Phosphates or trace nutritional elements (Zn, Cu, Mn, Co, Ni, Mo, Cl, Se, and others) function to compensate for shortages in the organic material (e.g. in corn) in the fermenter.

Organic substances are preferably used as a fifth component. Amino acids and/or proteins, (vegetable, animal, or synthetic) improve the composition and the activity of the microorganisms, in particular when food waste is used.

The symbiosis between acetogenic and methanogenic bacteria and the biological equilibrium is maintained; only the decomposition of the organic substances is accelerated. The promotion of the acetogenic and methanogenic bacteria leads to decomposition of ethanoic acid, propanoic acid, among other organic acids, and a “tipping” in the packaging unit is prevented.

According to other advantageous embodiments of the encasing material according to the invention, at least one layer has a reinforced perforated edge or a bottom and at least one side wall, [and has] a regulating functional unit thereby between layers, in particular a paste or sealing liquid, which guarantees the gas tightness of the casing during deformation thereof.

Additional advantageous embodiments of encasing materials according to the invention have two or more films, which may be connected to one another by embossing a gas-tight seam so that a cavity results.

According to other advantageous embodiments of encasing materials according to the invention, at least one inner layer reacts to the materials packaged in the casing through contact or outgassing, in particular, said layer shrinks upon contact with urine.

According to other advantageous embodiments of encasing materials according to the invention, the casing is heat sealable at a maximum of 70° C.

According to other advantageous embodiments of encasing materials according to the invention, at least one layer is metal coated, so that after creasing, the shock waves generated thereby cause a spontaneous crystallization of a salt of an supersaturated solution incorporated in an intermediate layer, whereby heat is released.

According to other advantageous embodiments of encasing materials according to the invention, the surface of the encasing material facing the secondary biological material after the encasement has methane producers or methanogens, and methane production occurs during the energy metabolism thereof.

According to other advantageous embodiments of encasing materials according to the invention, the casing has an adhesive, in particular an adhesive that may be cured by means of an external energy source, for example, during unwinding from a cartridge.

According to other advantageous embodiments of encasing materials according to the invention, a strongly absorbent material is distributed between two films so that moisture penetrating a micro-perforated film causes the absorbent material to swell and by this means seals the film.

According to other advantageous embodiments of encasing materials according to the invention, the layer with diverse films has a classifying effect so that the casing enriches specific materials in specific areas.

The term film is understood here as not limited to plastic material. Film may, according to the understanding of this description, also be composed at least partially from paper, latex, or rubber.

The invention is subsequently described in greater detail with the aid of the embodiments depicted in the figures. As seen in:

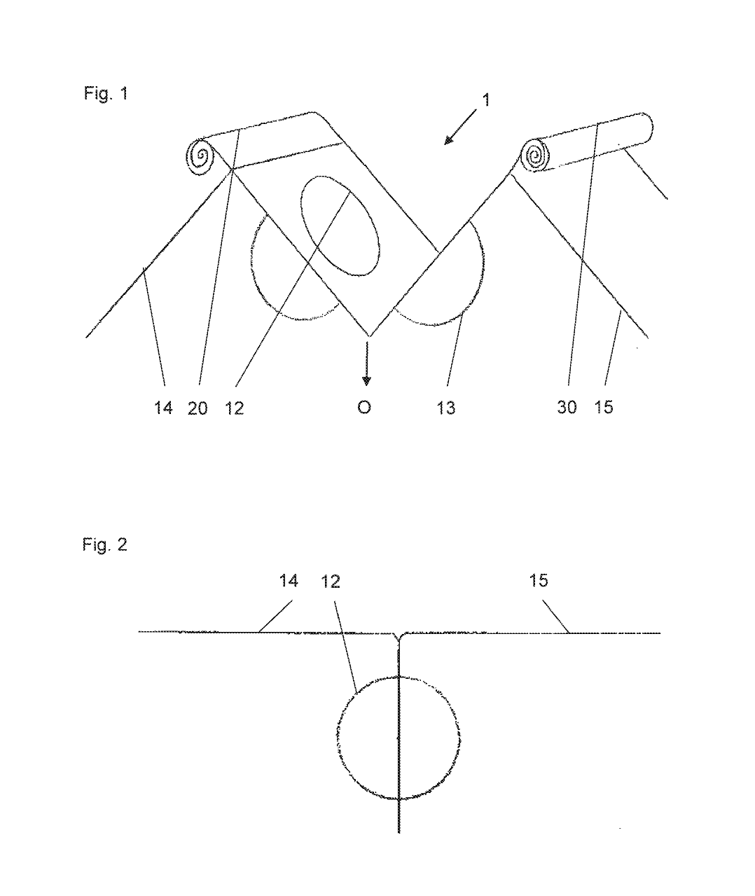

FIG. 1 a schematic depiction with a perspective view on parts essential to the function of an encasing device according to the invention in an open loading position,

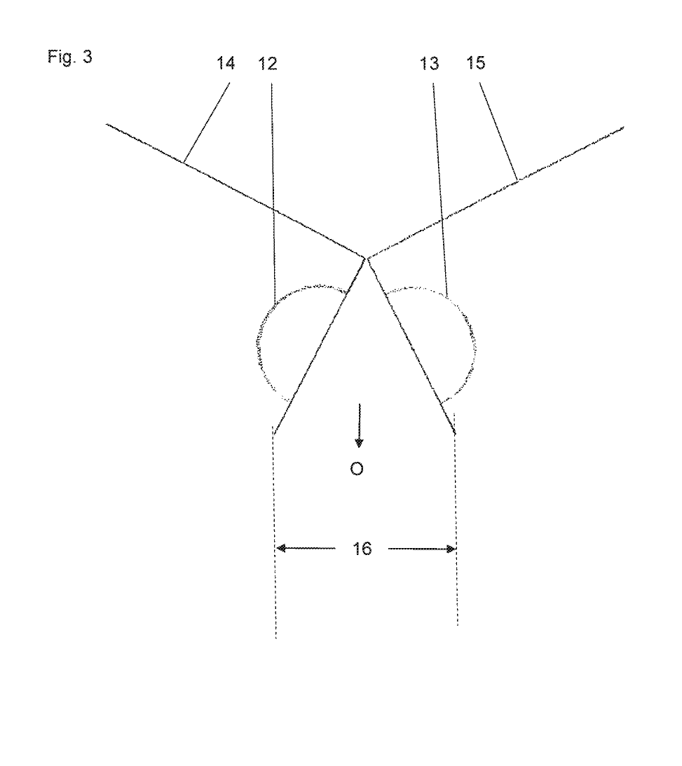

FIG. 2 the encasing device from FIG. 1 in a highly simplified sketch in a closed, sealing position,

FIG. 3 the encasing device from FIG. 1 in a highly simplified sketch in an ejection position open toward the bottom,

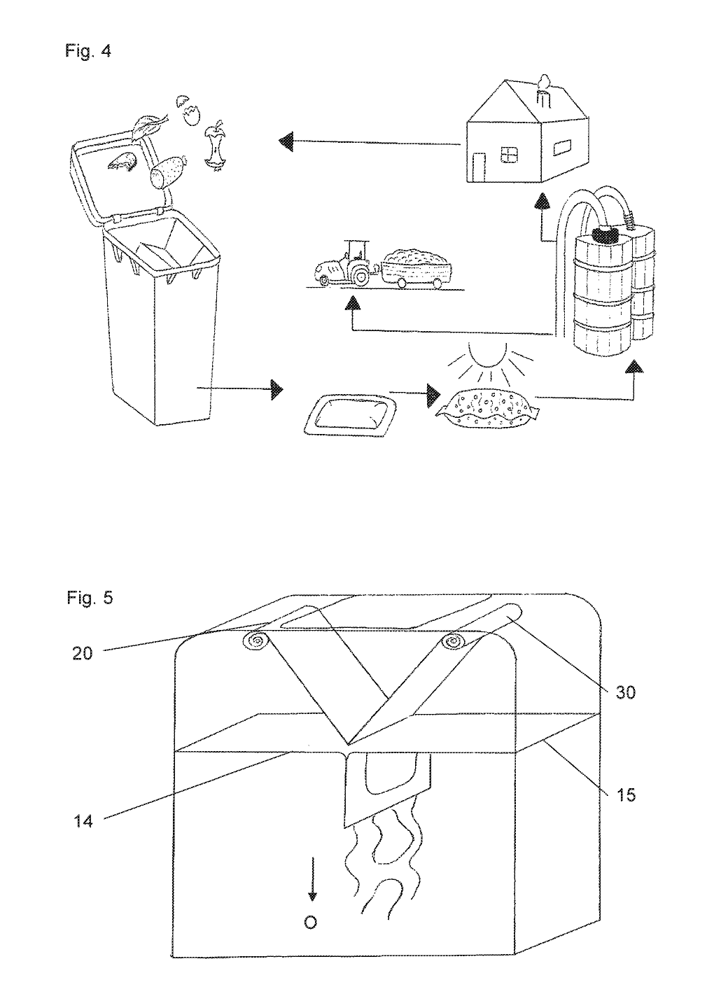

FIG. 4 a graphic depiction of the method steps of the method according to the invention for converting secondary biological materials into reusable energy and for storing the secondary biological materials,

FIG. 5 a perspective sketch of a trashcan comprising the encasing device according to the invention according to FIG. 2 in a closed, sealing position,

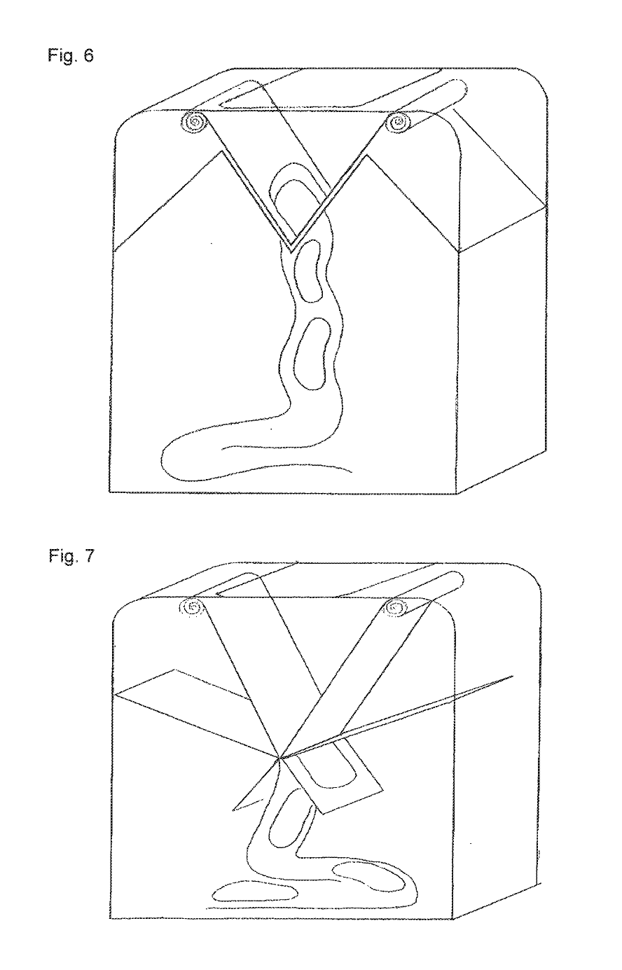

FIG. 6 the trashcan from FIG. 5 in the open, loading position according to FIG. 1,

FIG. 7 the trashcan from FIG. 5 in the ejection position according to FIG. 3,

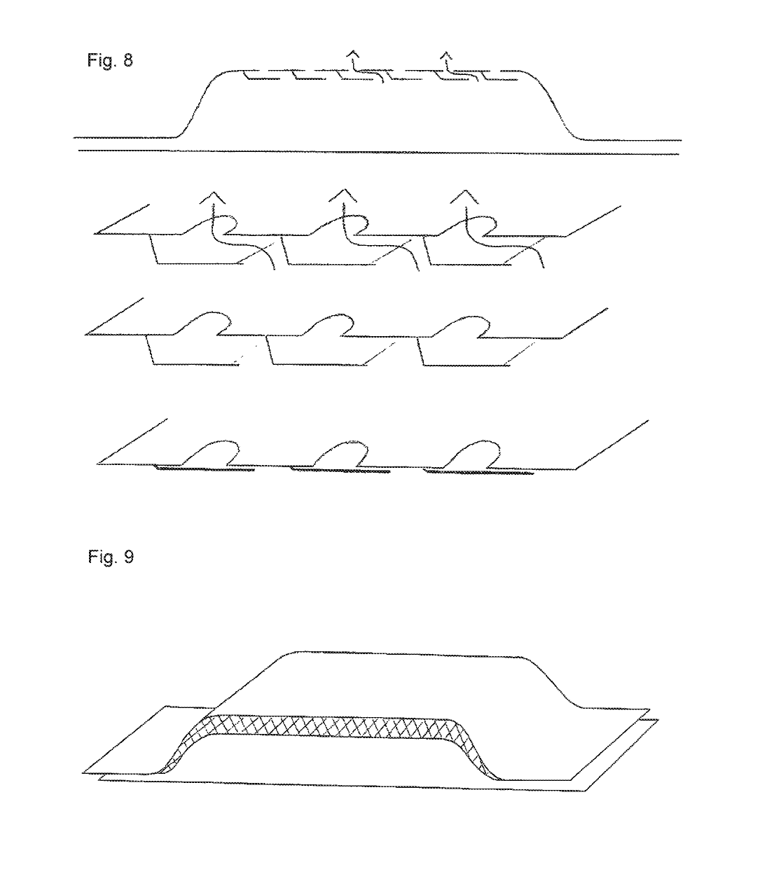

FIG. 8 sketches of the encasing material according to the invention according to diverse embodiments,

FIGS. 9 through 13 sketches of additional embodiments of an encasing material.

One embodiment of an encasing device 1 for sealing secondary biological material in portions in a sealed encasing for each portion is sketched in FIGS. 1 through 3 and 5 through 7. Encasing device 1 has a filling opening 12 for accommodating a portion of the secondary biological material to be sealed on an encasing material 20 in an accommodation body 14. In this depicted embodiment, a second accommodation body 15 positioned symmetrically opposite accommodation body 14, via which second accommodation body an encasing material 30 likewise runs out in movement direction O. Both encasing materials accommodate the secondary organic material between themselves in this embodiment.

Accommodation bodies 14, 15 are accommodated in a common movement coordinator, not shown, which ensures a forward propulsion of the portion in at least movement direction O. For this purpose, the movement coordinator moves two accommodation bodies in one single, synchronous, identical movement, resulting from an open loading position (FIGS. 1, 6) into a closed sealing position (FIGS. 2, 5) transitioning into an ejection position open toward the bottom (FIGS. 3, 7).

Filling opening 12 is arranged between two cartridges, not shown, each filled with encasing material 20, 30, when viewed transverse to movement direction O.

Accommodation bodies 14, 15 function in their sealing position as a combining means, which is arranged in the area of filling opening 12, namely around it, in order to join encasing materials 20, 30 to one another surrounding the secondary biological material. The single movement influenced by the movement coordinator causes in identical movement paths—a closing of accommodation opening 12 with compression and/or volume changes of an accommodation mold, sealing of the casing, and ejection of the packaged portion—occurring following one another or at least partially simultaneously.

In FIG. 4, the method according to the invention for converting secondary biological material into reusable energy and storing the biological material is sketched out. This method, according to the embodiment depicted, initially removes the secondary biological material from a biological bin. The secondary biological material is packaged in portions in at least one layer of gas-tight encasing material. The packaged material is transported and preferably stored in the sun, wherein the encasing material and/or a material added to the secondary biological material promotes at least gas formation in the casing and/or classifies urine in a separate fraction and/or separates another useful fraction. For example, a fermentation processes advantageously occurs.

The portions then arrive, in the embodiment depicted, in processing towers, in which methane gas is initially removed. The degassed encasings are subsequently incinerated, for example, for heating a house.

In FIG. 8, embodiments of encasing materials according to the invention are roughly sketched in their structure. An upper area of a casing might have a film section made from memory plastic. The pores of which open and close according to temperature, pressure, or tension. The valve function is sketched with open and closed valve covers. The valve function is, for example, electrostatically activated or mechanically activated by the swelling of intermediate material.

FIG. 9 shows a heat-insulating outer film having powdered iron, table salt, activated carbon, and/or water. Thus, an exothermic reaction may be triggered in a targeted way according to an advantageous embodiment.

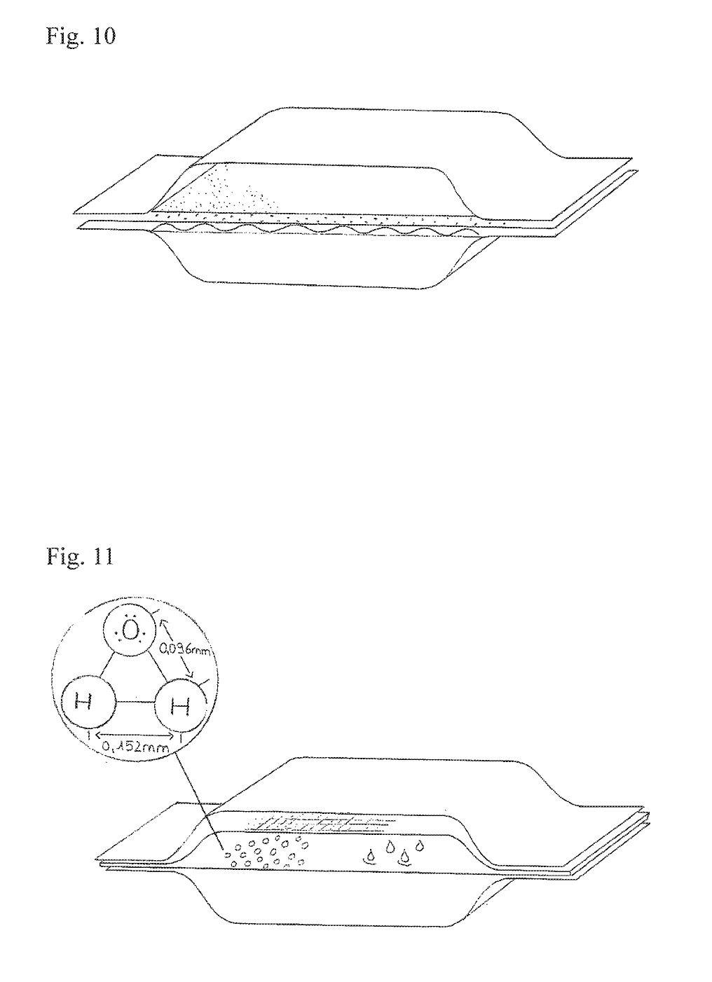

Alternatively according to FIG. 10, a separating layer may provide a division into two main chambers. At least one of the films used in this embodiment is coated with a methane gas generator. Another film is coated with an absorber.

According to FIG. 11, the separating layer has pore sizes of approximately 0.15 mm in order to permit water molecules to permeate. Another film allows methane gas to pass in only one direction into a specific chamber in a targeted way. A classifying effect thus occurs.

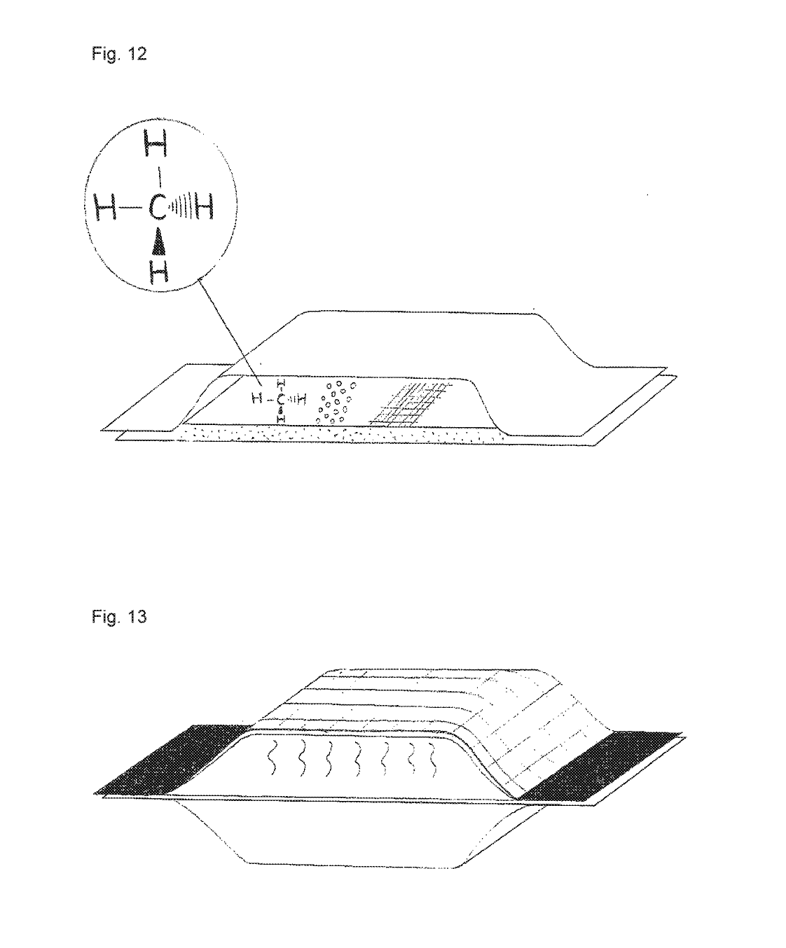

According to FIG. 12, the structure of a film takes into consideration the molecular size and spatial structure of methane. An outer sleeve is gas-tight in any case according to this embodiment, in particular with respect to methane gas. In contrast, an inner membrane facing the secondary organic material allows the membrane gas to pass into a separate chamber.

FIG. 13 shows a film with solar energy stores. For example, a coating is provided with fluorescing properties. An outer film is partially colored black. Thus, the function of a natural plant leaf is almost achieved.

1. A method for converting secondary biological material into reusable energy and for storing said material, said method initially packages the secondary biological material in portions in at least one gas-tight encasing material in at least one layer, the packaged material is transported and stored, wherein the encasing material and/or a material added to the secondary biological material promotes formation of at least one gas in the casing and/or classifies urine into a separate fraction and/or separates another useful fraction.

2. The method according to claim 1, characterized in that after or during the gas formation of multiple encasings filled according to the method according to claim 1, only the gas is initially removed in a gas removal step, and that following the gas removal step, the still filled, at least partially degassed encasings are supplied to a recycling or incineration step.

3. An encasing method for sealing secondary biological material in portions in casings comprising:
at least one transport device for at least one first, gas-tight encasing material (20, 30) in at least one layer, said transport device is designed to form an accommodation depression (12) jointly with the first encasing material (20),
at least one sealing device, which is designed to seal the secondary biological material, in a gas-tight way, by means of bringing the biologically degradable encasing material into contact at least with itself or with another biologically degradable encasing material, by means of positive locking, gluing, and/or heat sealing, and/or another sealing principle, and
at least one body (14, 15) that can be moved for the sealing,
wherein the secondary biological material inserted into the accommodation depression (12) is sealed in case of its compressibility, or it is forced into the accommodation depression filling up the same; in any case, the secondary biological material is at least substantially subjected to vacuum before sealing,
wherein a not yet completely sealed contact area of the casing remains open until a rear end of the casing is sealed.

4. The encasing device (1) for sealing secondary biological material in portions in a casing sealed for each portion, comprising:
at least one filling opening (12) for accommodating a portion of the secondary biological material to be sealed on an encasing material (20) in at least one receiving body (14),
a movement coordinator for a forward movement of the portion in at least one movement direction (O),
wherein either
the filling opening (12) is arranged between at least two cartridges filled with at least one encasing material (20) or with the identical or different encasing materials (20, 30), when viewed transverse to the movement direction (O),
or at least one such cartridge (20, 30) supplies at least two identical or different encasing materials, said encasing materials are separately present or can be separated from one another before reaching the filling opening, when viewed in the movement direction (O),
and comprising a combining means, which is arranged in the area of the filling opening or above the filling opening (12) in order to join the encasing material to itself or the encasing materials to one another enclosing the secondary biological material,
wherein a single movement influenced by the movement coordinator causes in identical movement path of at least the accommodation body (14)
a closing of the accommodation opening with compression and/or volume changes of an accommodation mold,
sealing of the casing,
and ejection of the packaged portion
occurring following one another or at least partially simultaneously.

5. An encasing material, comprising a flat, single layer web or multiple flat webs in multiple layers or a tube, namely made of plastic film(s) and/or paper, comprising at least one gas-impermeable layer, in particular having at least one of the following properties:
in at least one layer: impermeability for all gases, beginning with the molecular size of methane and larger,
in at least one layer: a membrane for separating urine,
a perforated interior side,
at least in one layer: an osmosis filter acting as a vacuum,
different hardness grades in zones, in particular in zones between layers,
reactive material between layers,
at least one valve layer, having sealable pores, said pores closing in particular during filling or inflating after gas development,
layers permeable to gas from inside to outside, in particular to trap methane between two outer layers,
layers permeable to gas from outside to inside, in particular to guide oxygen to, for example, encased meat so that aerobic processes are promoted,
shrinkable due to temperature influences, to change the volume of the casing, in particular to support vacuum application,
one at least partially deep-drawn layer,
encasing coated with materials or nutrient media that react upon contact with the secondary biological material,
a protective film on at least one side of the casing, after removal of said film, a residual monomer is released and comes into contact with the secondary biological material,
a layer that decomposes after a certain time,
a phosphorizing layer, whose radiation is preferably activated during the encasing, particular preferably by means of electrostatic activation during unrolling of an encasing material,
a fluorescing layer for activating processes in the secondary biological material,
an intermediate layer made from activated carbon, in particular in the case of secondary biological materials which exude poisonous vapors,
a water layer in the case of a disposal of radioactive secondary biological material, for example, in a hospital,
a surface with micro beads that burst during pressure and exude, for example, adhesive.

6. The encasing material according to claim 5, as part of a sterile packaging with internal glove, wherein the glove is manufactured from the encasing material.
